(19) United States
(12) Patent Application Publication
(10) Pub. No.: US 2016/0010893 A1
(43) Pub. Date: Jan. 14, 2016

(54) HEATING DEVICE

(71) Applicants: Hsuan-Yi Lu, Hsin-Chu (TW); Chung-Ping Wang, Hsin-Chu (TW); Yu-Hsiang Lin, Hsin-Chu (TW); Yi-Wei Yen, Hsin-Chu (TW)

(72) Inventors: Hsuan-Yi Lu, Hsin-Chu (TW); Chung-Ping Wang, Hsin-Chu (TW); Yu-Hsiang Lin, Hsin-Chu (TW); Yi-Wei Yen, Hsin-Chu (TW)

(73) Assignee: Coretronic Corporation, Hsin-Chu (TW)

(21) Appl. No.: 14/687,924

(22) Filed: Apr. 16, 2015

(30) Foreign Application Priority Data
Jul. 14, 2014 (CN) 201410333367.5

(51) Int. Cl. F24J 1/00; H01M 8/06

(52) U.S. Cl. CPC F24J 1/00; H01M 8/0606; H01M 2250/40

(57) ABSTRACT

A heating device including a heating unit, a temperature sensing module, a control unit, and a hydrogen generating unit having a first tank, a second tank, and a driving element is provided. The first tank contains a liquid reactant. The second tank contains a solid reactant. The driving element is connected between the first tank and the second tank, drives the liquid reactant to move from the first tank to the second tank, such that the liquid reactant reacts with the solid reactant to generate hydrogen. The heating unit is connected to the hydrogen generating unit and includes a catalyst layer. At least a part of hydrogen moves from the second tank to the heating unit and contacts the catalyst layer to react to generate heat energy. The control unit is electrically connected to the driving element, and controls the driving element according to a temperature of the heating device.

### CROSS-REFERENCE TO RELATED APPLICATION

This application claims the priority benefit of China application serial no.

201410333367.5, filed on Jul. 14, 2014. The entirety of the above-mentioned patent application is hereby incorporated by reference herein and made a part of this specification.

### BACKGROUND

1. Technical Field

The invention relates to a heating device, and particularly relates to a heating device capable of generating heat through chemical reaction of hydrogen.

2. Related Art

Presently, portable heaters generally produce heat by burning gas, and such flame type heater has a risk of causing fire. Another type of the portable heater uses a platinum group metal catalyst layer to catalyse hydrocarbon such as C₃H₈, etc. to produce chemical reaction with oxygen in the air, and generates heat energy required by the portable heater through the chemical reaction, and such non-flame type heater may reduce a chance of causing fire. However, when the portable heater that generates the heat energy through the chemical reaction of the C₃H₈ is operated, the catalyst layer has to be pre-heated to about 150 degrees centigrade in order to effectively catalyse the C₃H₈ to react with oxygen, which is time-consuming and energy-consuming.

Moreover, besides vaporous water is generated from the chemical reaction between the C₃H₈ and the oxygen, carbon dioxide and carbon monoxide are also generated, and if such type of the portable heater is used in a confined space, it probably causes carbon monoxide poisoning.

China Patent No. 101852333 discloses a heat providing system, which provides heat to a hydrogen storage material in a hydrogen storage tank, and a hydrogen consuming device receives a first hydrogen flow from the hydrogen storage tank, and a catalytic heater receives an oxygen flow and a second hydrogen flow come from the hydrogen storage tank. China Publication No. 102927571 discloses a hydrogen nozzle, which is applied to hydrogen energy non-ignition catalyst heater. China Publication No. 102944012 discloses a non-ignition catalyst heater using hydrogen as fuel. China Patent No. 102944103 discloses a non-ignition catalyst heating system using hydrogen as fuel. China Patent No. 202955687 discloses a non-ignition catalyst heater using hydrogen as fuel. China Publication No. 102494342 discloses an environmental friendly non-ignition catalyst hydrogen burning and heating system, in which ceramic fiber is used to make hydrogen to have an oxidation heat reaction. China Publication No. 1897343 discloses a fuel cell, which has a catalytic reaction heat based heater. China Publication No. 103213944 discloses a gas generation device, in which hydrogen generated through a chemical reaction of water and metal hydroxide is used by a fuel cell to produce electricity, and electric energy consuming devices such as light-emitting diodes (LEDs), etc. consume the electricity generated by the fuel cell.

The information disclosed in this BACKGROUND section is only for enhancement of understanding of the BACKGROUND of the described technology and therefore it may contain information that does not form the prior art that is already known to a person of ordinary skill in the art. Further, the information disclosed in the BACKGROUND section does not mean that one or more problems to be resolved by one or more embodiments of the invention was acknowledged by a person of ordinary skill in the art.

### SUMMARY

The invention is directed to a heating device, in which a catalyst layer is unnecessary to be pre-heated, and carbon monoxide harmful to human body is not generated during a using process of the heating device.

Other objects and advantages of the invention can be further illustrated by the technical features broadly embodied and described as follows.

In order to achieve one or a portion of or all of the objects or other objects, an embodiment of the invention provides a heating device including a hydrogen generating unit, a heating unit, a temperature sensing module, and a control unit. The hydrogen generating unit includes a first tank, a second tank, and a driving element. The first tank contains a liquid reactant, and the second tank contains a solid reactant. The driving element is connected to the first tank and the second tank, and is configured to drive the liquid reactant to move from the first tank to the second tank, such that the liquid reactant reacts with the solid reactant to generate hydrogen. The heating unit is connected to the hydrogen generating unit and includes a catalyst layer. At least a part of the hydrogen moves from the second tank to the heating unit and contacts the catalyst layer to react to generate heat energy. The temperature sensing module is configured to sense at least one temperature of the heating device and transits a temperature signal to the control unit. The control unit is electrically connected to the driving element, and controls the driving element according to the temperature of the heating device after receiving the temperature signal of the temperature sensing module.

In an embodiment of the invention, the control unit turns on or turns off the driving element according to the temperature.

In an embodiment of the invention, the control unit controls a working state of the driving element according to the at least one temperature, so as to change a flowing rate of the liquid reactant flowing to the second tank.

In an embodiment of the invention, the heating device further includes a fuel cell connected to the hydrogen generating unit. At least another part of the hydrogen moves to the fuel cell from the second tank, and reacts in the fuel cell to generate electric energy.

In an embodiment of the invention, the fuel cell is configured to supply electricity to the driving element.

In an embodiment of the invention, the heating device further includes an electronic module. The control unit is electrically connected to the fuel cell and the electronic module, and controls the fuel cell to supply electricity or not to supply electricity to the electronic module according to an amount of electricity of the electronic module.

In an embodiment of the invention, the electronic module includes an electric energy storage unit and an electronic component. The electric energy storage unit stores electric energy from the fuel cell and supplies electricity to the driving element and the electronic component, and the control unit controls the fuel cell to supply electricity or not to supply electricity to the electric energy storage unit according to the amount of electricity of the electric energy storage unit.

In an embodiment of the invention, the fuel cell is configured to supply electricity to the electronic component.

In an embodiment of the invention, when the amount of electricity of the electric energy storage unit is lower than a storage amount predetermined value, the control unit controls the electric energy storage unit to supply electricity to the driving element and not to supply electricity to the electronic component.

In an embodiment of the invention, the hydrogen generating unit includes an airflow channel and a first guide structure. The airflow channel is connected between the second tank and the heating unit. The first guide structure is connected between the second tank and the fuel cell. A part of the hydrogen in the second tank flows through the airflow channel to reach the heating unit. Another part of the hydrogen in the second tank flows through the first guide structure to reach the fuel cell. The second tank has a fourth guide structure, and the fourth guide structure is aligned to the solid reactant. The liquid reactant is configured to flow through the fourth guide structure to reach the solid reactant.

In an embodiment of the invention, the temperature sensing module includes a first temperature sensing element. The first temperature sensing element is disposed on and electrically connected to the control unit. The first temperature sensing element senses a first temperature of the heating device at the control unit. The at least one temperature includes the first temperature.

In an embodiment of the invention, the temperature sensing module includes a second temperature sensing element. The second temperature sensing element is disposed on the hydrogen generating unit and is electrically connected to the control unit. The second temperature sensing element senses a second temperature of the heating device at the hydrogen generating unit. The at least one temperature includes the second temperature.

In an embodiment of the invention, the temperature sensing module includes a third temperature sensing element. The third temperature sensing element is disposed on the heating unit and is electrically connected to the control unit. The third temperature sensing element senses a third temperature of the heating device at the heating unit. The at least one temperature includes the third temperature.

In an embodiment of the invention, the heating device further includes a safety protection module. The safety protection module is electrically connected to the control unit for sending a safety signal to the control unit, such that the control unit turns off the driving element.

In an embodiment of the invention, the safety protection module includes a horizontal sensing element. The horizontal sensing element is electrically connected to the control unit. When the horizontal sensing element senses an inclining angle of the heating device to be greater than an inclining angle predetermined value, the control unit turns off the driving element.

In an embodiment of the invention, the safety protection module includes a contact sensing element. The contact sensing element is disposed on the first tank and is electrically connected to the control unit. When the contact sensing element senses that the second tank is separated from the first tank, the control unit turns off the driving element.

In an embodiment of the invention, the safety protection module includes a water level sensing element. The water level sensing element is disposed on the first tank and is electrically connected to the control unit. When the water level sensing element senses that a water level of the liquid reactant in the first tank is lower than a water level predetermined value, the control unit turns off the driving element.

In an embodiment of the invention, the heating device further includes a fuel cell. The safety protection module includes a position sensing element. The fuel cell is detachably connected to the hydrogen generating unit. At least another part of the hydrogen moves to the fuel cell from the second tank, and reacts in the fuel cell to generate electric energy. The position sensing element is disposed on the hydrogen generating unit and is electrically connected to the control unit. When the position sensing element senses that the fuel cell is detached from the hydrogen generating unit, the control unit turns off the driving element.

In an embodiment of the invention, the first tank has an annular space, and the annular space contains the liquid reactant and surrounds the second tank.

In an embodiment of the invention, the heating unit includes a porous structure, and the porous structure is disposed between the catalyst layer and the hydrogen generating unit.

According to the above description, the embodiment of the invention has at least one of the following advantages. In the heating device of the embodiment of the invention, the hydrogen generating unit is used to generate the hydrogen, and the hydrogen is reacted with the oxygen in the air through catalysis of the catalyst layer to produce heat energy. Since the heating device of the embodiment of the invention produces the heat energy without using a conventional reaction of hydrocarbon and oxygen in the air reacted by the conventional heating device, carbon monoxide hannful to human body is not generated, and none flame is generated, such that usage safety of the heating device is improved. Moreover, based on high activity of the hydrogen, the catalyst layer may quickly and effectively catalyse the reaction of the hydrogen and the oxygen to generate heat energy, such that the heating device is more energy-saving and time-saving in usage. In addition, in the heating device of the embodiment of the invention, the driving element is used to drive the liquid reactant to move towards the solid reactant, the control unit is used to control the operation of the driving element according to the temperature of the heating device, and a flowing rate of the liquid reactant flowing to the second tank is automatically adjusted according to a heating quantity requirement, an environmental temperature, and a temperature of the hydrogen generating unit, so as to control a generating rate of the hydrogen generated through the reaction of the liquid reactant and the solid reactant and an amount of the generated hydrogen, such that the heating device is more convenient in usage. Moreover, the heating device of the embodiment of the invention further includes a safety protection module electrically connected to the control unit for detecting whether a usage state of the heating device is normal. If the heating device is in an abnormal usage state, a safety signal is sent to the control unit and the control unit turns off or does not turn on the driving element, so that the usage safety of the heating device is enhanced.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of a heating device according to an embodiment of the invention.

FIG. 2 is an exploded view of a part of components of the heating device of FIG. 1.

FIG. 3 is a block diagram of a part of components of the heating device of

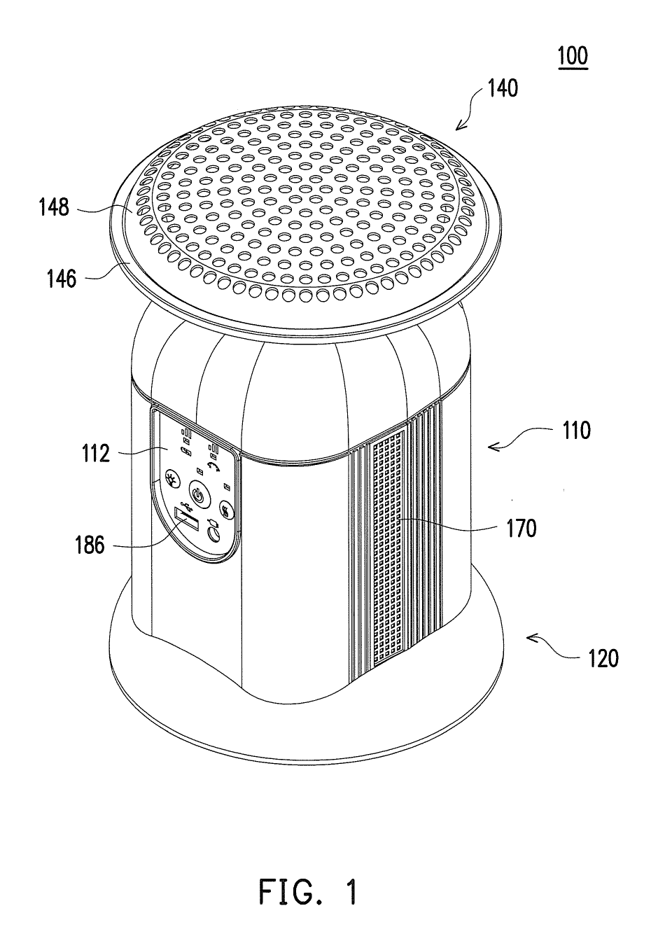

FIG. 1.

FIG. 4 is an exploded view of the heating unit of FIG. 1.

FIG. 5 is a three-dimensional view of a part of components of the heating device of FIG. 1.

FIG. 6 is a partial structure of the heating device of FIG. 5.

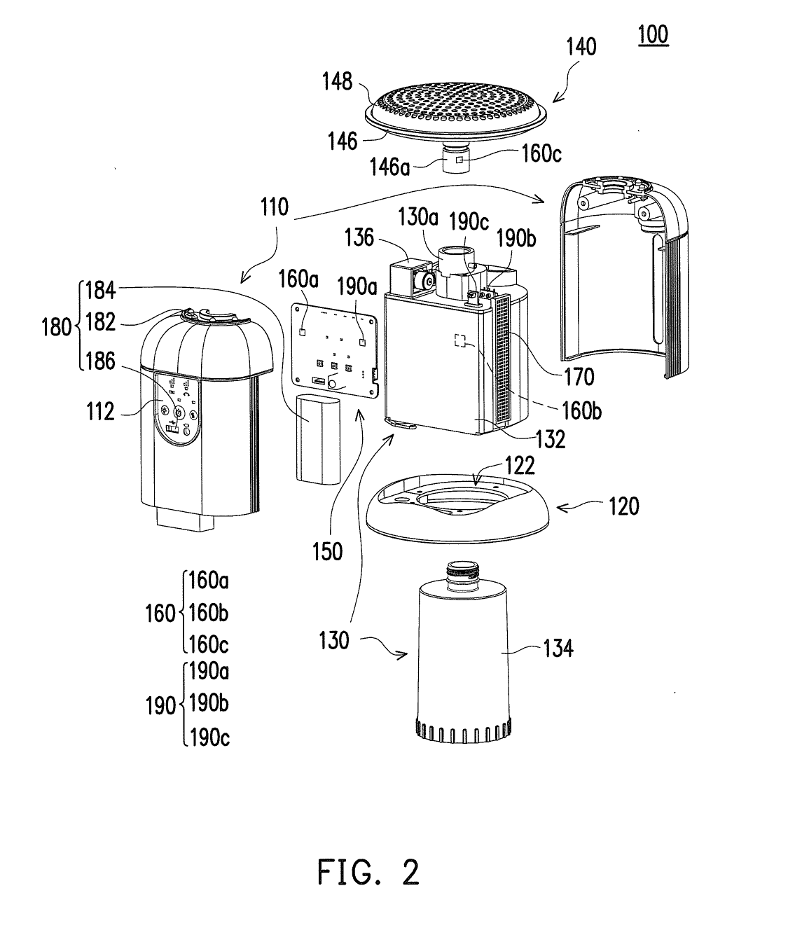

FIG. 7 is an exploded view of a second tank of FIG. 2.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

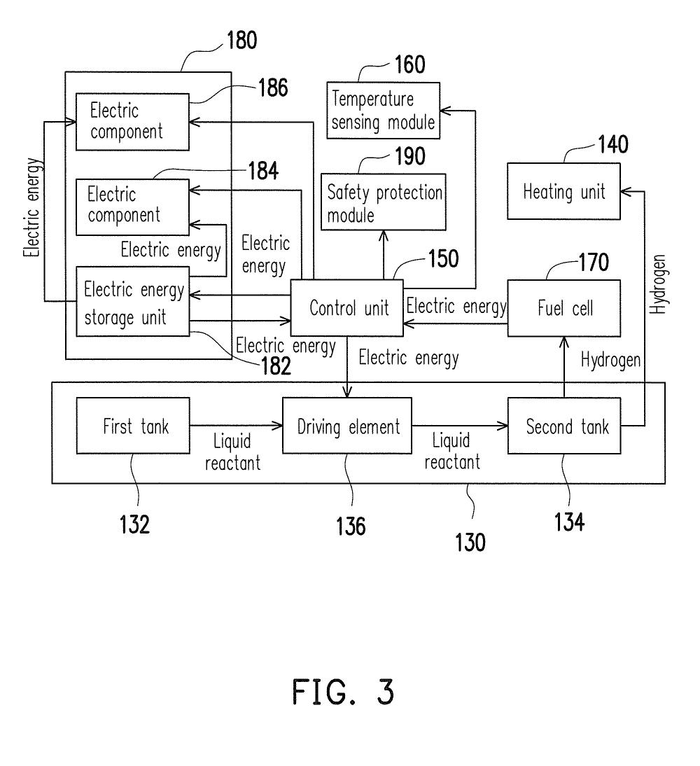

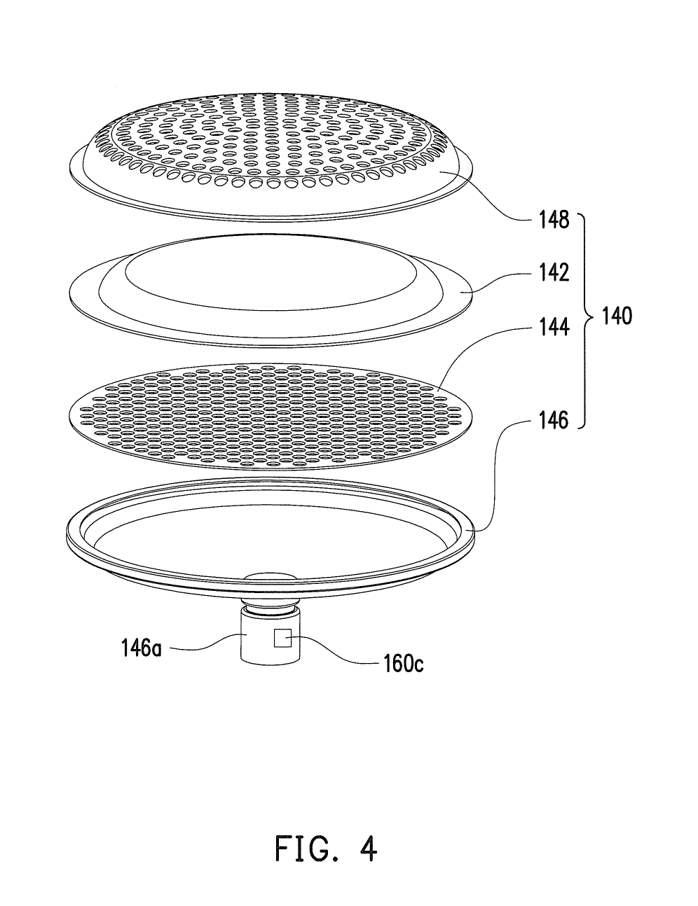

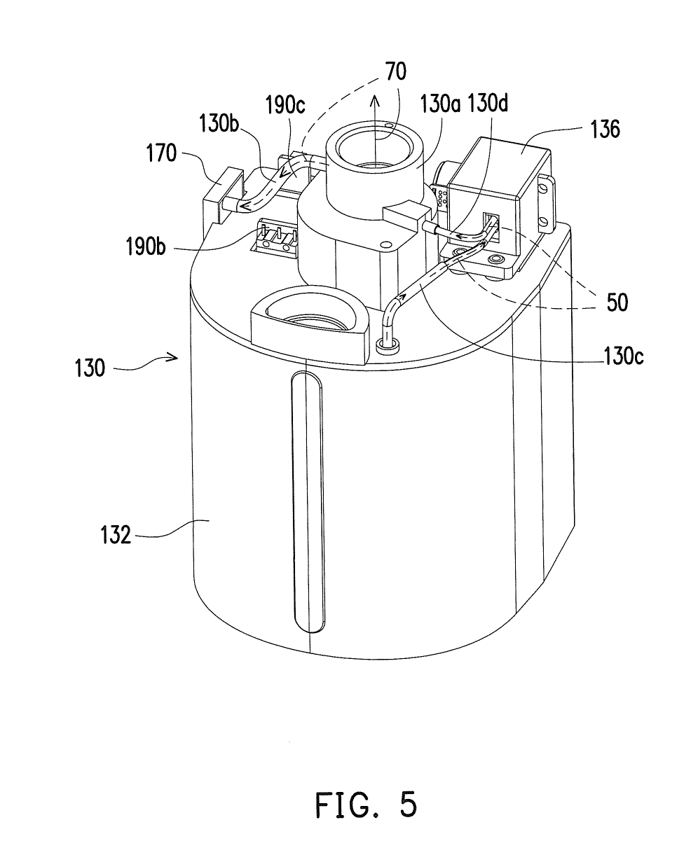

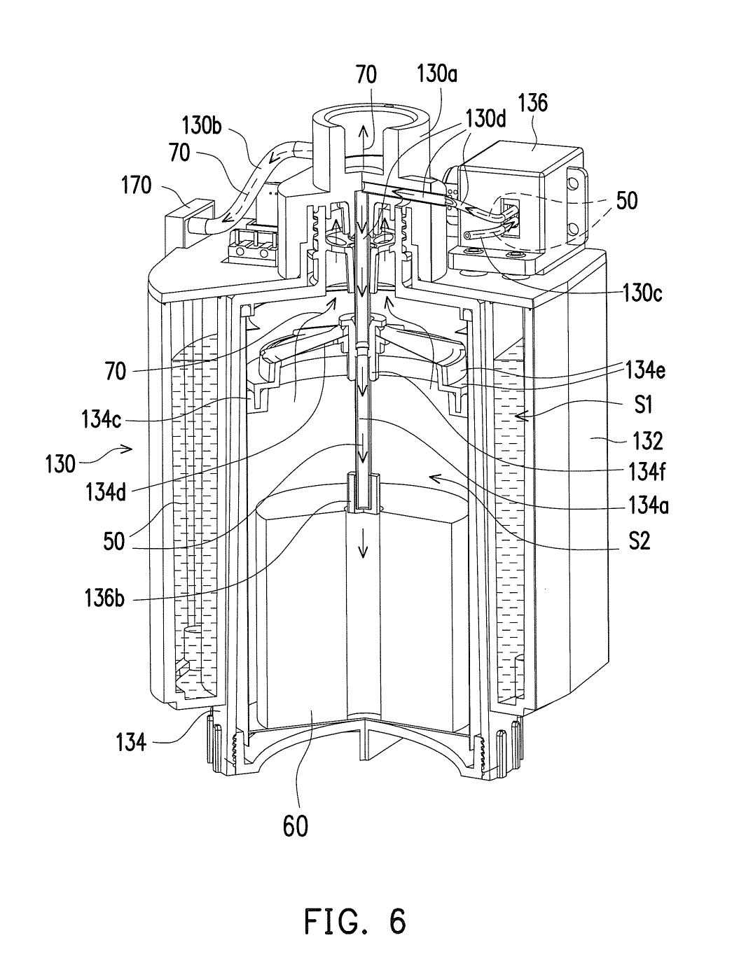

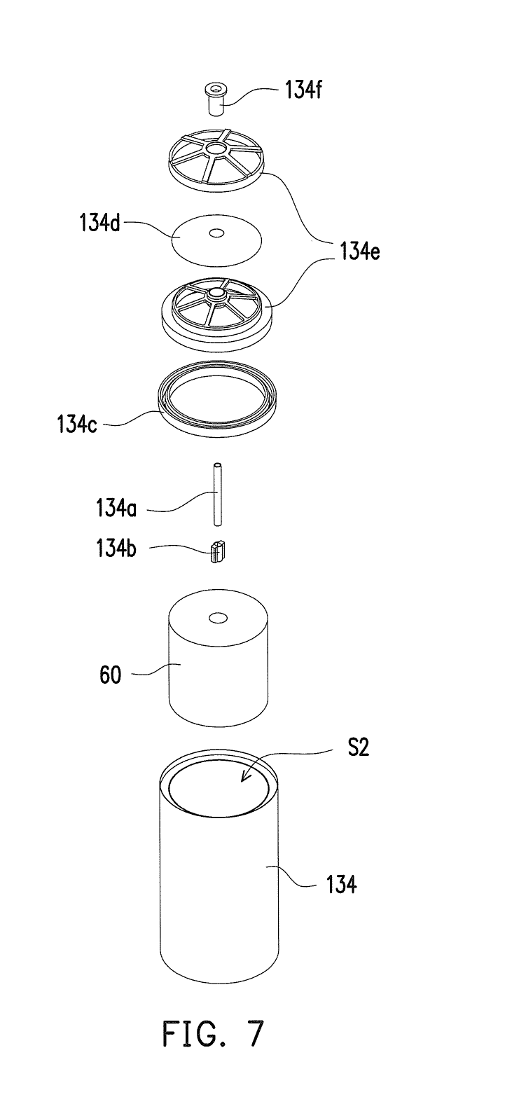

Referring to FIG. 1 to FIG. 3, the heating device 100 of the embodiment is, for example, a portable heater and includes a casing 110, a base 120, a hydrogen generating unit 130, and a heating unit 140. The hydrogen generating unit 130 includes a first tank 132, a second tank 134, and a driving element 136. The first tank 132 and the second tank 134 are respectively used for containing a liquid reactant and a solid reactant. The driving element 136 is disposed/assembled/configured on the first tank 132 and is connected to the first tank 132 and the second tank 134. The driving element 136 is, for example, a pump or other suitable driving elements, and is used for driving the liquid reactant to move from the first tank 132 to the second tank 134, such that the liquid reactant reacts with the solid reactant to generate hydrogen.

Referring to FIG. 2 and FIG. 4, the first tank 132 is disposed/assembled/configured on the base 120 and is wrapped by the casing 110, and the casing 110 has an operation interface 112 to facilitate user's operation. The heating unit 140 is connected to the top of the first tank 132 of the hydrogen generating unit 130 and includes a catalyst layer 142. The second tank 134 is, for example, a disposable tank/can and may be plugged/unplugged to/from the first tank 132 through an opening 122 of the base 120. At least a part of the hydrogen generated through reaction of the liquid reactant and the solid reactant is moved to the heating unit 140 from the second tank 134 and contacts the catalyst layer 142 to react with the oxygen in the air to generate heat energy. A material of the catalyst layer 142 may include platinum group metals or other suitable catalyst materials, which is not limited by the invention.

Since the heating device 100 of the embodiment generates the heat energy without the conventional reaction reacted by the conventional heating device using hydrocarbon and oxygen, but generates the heat energy through reaction of hydrogen and oxygen, such that carbon monoxide harmful to human body is not generated and the heating device 100 has higher usage security. Moreover, through high activity of the hydrogen, the catalyst layer 142 may quickly and effectively catalyse reaction of the hydrogen and the oxygen to generate the heat energy, such that the heating device 100 is more energy-saving and time-saving in usage.

In the embodiment, the liquid reactant is, for example, liquid water (H₂O), and the solid reactant may be a solid hydride, for example, solid sodium borohydride (NaBH₄) added with proper solid catalyst, and the solid sodium borohydride is reacted with the liquid water to generate hydrogen, wherein a reaction formula thereof is

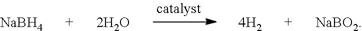

Moreover, the liquid reactant may also be acidic water solution, and the solid sodium borohydride is reacted with the acidic water solution to generate hydrogen, wherein a reaction formula thereof is 2NaBH₄+2H⁺→B₂H₆+2Na⁺+2H₂. In another embodiment, the liquid reactant may also be a water solution generated by solid hydride added with water and the solid reactant may include a solid catalyst, and hydrogen is generated when the water solution contacts the solid catalyst in the solid reactant. In other embodiments, the hydrogen may be generated through reaction of other suitable types of solid reactant and liquid reactant, which is not limited by the invention.

For example, the solid reactant may be other types of solid hydride, such as boron hydride/borohydride, nitrogen hydride, carbon hydride/hydrocarbon, metal hydride, boron nitrogen hydride, boron carbon hydride, nitrogen carbon hydride, metal boron hydride/borohydride, metal nitrogen hydride, metal carbon hydride/hydrocarbon, metal boron nitrogen hydride, metal boron carbon hydride, metal carbon nitrogen hydride, boron carbon nitrogen hydride/boron nitrogen carbon hydride, metal boron carbon nitrogen hydride/boron nitrogen carbon hydride, or a combination thereof, and besides the sodium borohydride (NaBH₄), the solid hydride further includes but not limited to NaH, LiBH₄, LiH, CaH₂, Ca(BH₄)₂, MgBH₄, KBH₄ or/and Al(BH₃)₃. Moreover, the solid reactant may be various compounds with a common formula of BxNyHz including but not limited to H₃BNH₃, H₂B(NH₃)₂BH₃, NH₂BH₂, B₃N₃H₆, morpholineborane (C₄H₁₂BNO), borane-(CH₂)₄O, B₂H₄, or a combination thereof. The solid catalyst may be solid acid or salts containing Ru, Co, Ni, Cu, Fe, or a solid catalyst formed by using ions thereof.

The heating device 100 of the embodiment further includes a control unit 150, and the control unit 150 is, for example, a control circuit board, and is electrically connected to the driving element 136. The control unit 150 controls the driving element 136 according to at least one temperature of the heating device 100. Regarding the operation that the control unit 150 controls the driving element 136 according to the temperature of the heating device 100, a flowing rate and flowing quantity of the liquid reactant flowing to the second tank 134 are automatically adjusted according to a heating quantity requirement, an environmental temperature, and a temperature of the hydrogen generating unit 130, so as to control a generating rate/velocity of the hydrogen generated via reaction of the liquid reactant and the solid reactant and an amount of the generated hydrogen, such that the heating device 100 is more convenient and safe in usage.

A detailed method that the control unit 150 controls the driving element 136 according to at least one temperature of the heating device 100 is described below. Referring to FIG. 2, the heating device 100 of the embodiment includes a temperature sensing module 160 electrically connected to the control unit 150 to form a feedback circuit for sensing the at least one temperature of the heating device 100 and transmitting a temperature signal to the control unit 150. The temperature sensing module 160 includes a first temperature sensing element 160a. The first temperature sensing element 160a is electrically connected to the control unit 150. The first temperature sensing element 160a is used for sensing a first temperature (which may be regarded as an environmental temperature) of the heating device 100 at the control unit 150. The first temperature sensing element 160a may be disposed on the control unit 150 for sensing the environmental temperature; in other embodiments, the first temperature sensing element 160a may also be disposed on the casing 110, the base 120 or the hydrogen generating unit 130, etc. of the heating device 100 for sensing the environmental temperature, though the invention is not limited thereto. The control unit 150 controls a working state of the driving element 136 according to the first temperature for changing the flowing rate of the liquid reactant flowing to the second tank 134, such that the liquid reactant and the solid reactant have a proper initial reaction rate. An initial reaction temperature is the environmental temperature when the liquid reactant and the solid reactant initially react to generate hydrogen and the reaction rate is faster if the environmental temperature is relatively high (the reaction rate is slower if the environmental temperature is relatively low), so a larger amount of the liquid reactant is required to be delivered to the second tank 134 when the environmental temperature is too low, such that the amount of the generated hydrogen may quickly meet a standard of a required amount. For example, a temperature signal is output to the control unit 150 and the control unit 150 controls the driving element 136 to increase the flowing rate of the liquid reactant flowing to the second tank 134 if the first temperature sensed by the first temperature sensing element 160a is lower than a predetermined lowest environmental temperature, so as to increase a generating rate of the hydrogen for supplying the hydrogen to the heating unit 140 at once to generate heat.

The temperature sensing module 160 of the embodiment further includes a second temperature sensing element 160b. The second temperature sensing element 160b is disposed on the hydrogen generating unit 130 and is electrically connected to the control unit 150. The second temperature sensing element 160b is used for sensing a temperature of the heating device 100 at the hydrogen generating unit 130. In detail, the second temperature sensing element 160b may be disposed on the first tank 132 at a place close to the second tank 134 for sensing a second temperature of the second tank 134 in the heating device 100, i.e. the temperature of the hydrogen generating unit 130 mentioned above (which is equivalent a instantaneous reaction temperature of the liquid reactant and the solid reactant). The control unit 150 determines whether the hydrogen generating unit 130 is overheated due to the reaction of the liquid reactant and the solid reactant according to the second temperature. The second temperature sensing element 160b outputs a temperature signal to the control unit 150 and the control unit 150 turns off the driving element 136 according to the temperature signal if the second temperature sensed by the second temperature sensing element 160b is higher than a highest reaction temperature predetermined value, so as to avoid overheating of the hydrogen generating unit 130 due to continuous operation thereof. The control unit 150 turns on the driving element 136 according to the second temperature if the second temperature sensed by the second temperature sensing element 160b is lower than the highest reaction temperature predetermined value, so as to drive the hydrogen generating unit 130 to operate. In another embodiment, the first temperature sensing element 160a and the second temperature sensing element 160b may be a same temperature sensing element, and the initial temperature sensed by the temperature sensing element is the first temperature and a second temperature is sensed after a period of reaction when the heating device 100 is turned on to work initially.

The temperature sensing module 160 of the embodiment further includes a third temperature sensing element 160c. The third temperature sensing element 160c is disposed on the heating unit 140 and is electrically connected to the control unit 150. The third temperature sensing element 160c is used for sensing a third temperature (which is equivalent to a heating quantity requirement/demand) of the heating device 100 at the heating unit 140. A temperature signal is output to the control unit 150 and the control unit 150 determines that the heating unit 140 has enough heating quantity/value and slows down the operation of the driving element 136 according to the third temperature if the third temperature sensed by the third temperature sensing element 160c is higher than a heating temperature predetermined value, such that the flowing rate of the liquid reactant flowing to the second tank 134 is deceased to reduce the generating rate of hydrogen, or the driving element 136 is turned off to reduce the amount of the generated hydrogen. The control unit 150 determines that the heating quantity/value of the heating unit 140 is inadequate and turns on the driving element 136 according to the third temperature if the third temperature sensed by the third temperature sensing element 160c is lower than the heating temperature predetermined value, such that the hydrogen generating unit 130 continuously provides hydrogen to the heating unit 140 for reacting to generate heat, or the operation of the driving element 136 is speed up to increase the flowing rate of the liquid reactant flowing to the second tank 134, so as to increase the generating rate of hydrogen. The first temperature sensing element 160a, the second temperature sensing element 160b, and the third temperature sensing element 160c are, for example, temperature sensors.

As described above, the control unit 150 may control the operation of the driving element 136 according to the first temperature, the second temperature, and the third temperature of the heating device 100, so as to be able to adjust the flowing rate and flowing amount of the liquid reactant flowing to the second tank 134 according to the heating quantity requirement, the environmental temperature, and the temperature of the hydrogen generating unit 130, and predetermined temperatures of different phases/stages may be set to control the hydrogen generating process, such that generation of the hydrogen may be more efficient, and a hydrogen consuming amount of the heating device 100 is saved and usage safety thereof is improved.

Referring to FIG. 1 to FIG. 3, the heating device 100 of the embodiment further includes a fuel cell 170, and the fuel cell 170 is connected to the hydrogen generating unit 130. At least another part of the hydrogen generated by the hydrogen generating unit 130 is moved to the fuel cell 170 from the second tank 134, and reacts in the fuel cell 170 to generate electric energy. In the embodiment, the fuel cell 170 is a single side planar cell stack. Moreover, the fuel cell 170 may also be a proton exchange membrane fuel cell (PEMFC), an alkaline fuel cell (AFC), a phosphate fuel cell (PAFC), a molten carbonate fuel cell (MCFC), solid oxide fuel cell (SOFC), or other fuel cells using hydrogen to produce electricity. The electric energy generated by the fuel cell 170 may be supplied to the driving element 136 and the other components of the heating device 100, for example, the heating device 100 further includes an electronic module, and the control unit 150 is electrically connected to the fuel cell 170 and the electronic module and controls the fuel cell 170 to supply electricity or not to supply electricity to the electronic module according to an amount/a quantity of electricity of the electronic module, which is described in detail below.

The heating device 100 further includes an electronic module 180, and the electronic module 180 includes an electric energy storage unit 182, an electronic component 184, and an electronic component 186. The electric energy storage unit 182 is, for example, a lithium battery, and the electronic component 184 and the electronic component 186 are, for example, respectively a light-emitting device and a charging socket. The lithium battery is used for storing the electric energy come from the fuel cell 170 and supplying power to the driving element 136, the light-emitting device, and the charging socket; wherein the light-emitting device is, for example, a light-emitting diode, a laser diode, or a bulb used for providing an illumination light or a scene/situational light, and wherein the charging socket is, for example, a USB plug or other socket capable of charging an external device.

In another embodiment, the fuel cell 170 supplies power to the driving element 136, the electronic component 184, and the electronic component 186 only through the electric energy storage unit 182, and the control unit 150 is electrically connected to the fuel cell 170 and is electrically connected to the electronic module 180.

The control unit 150 controls the fuel cell 170 to supply electricity to the electric energy storage unit 182 of the electronic module 180, such that the electric energy storage unit 182 has enough electric energy for supplying to the driving element 136, the electronic component 184, and the electronic component 186. Moreover, the control unit 150 may control the electric energy storage unit 182 to only supply power to the driving element 136 without supplying power to the electronic component 184 and the electronic component 186 when the amount/quantity of electricity of the electric energy storage unit 182 is lower than a storage amount predetermined value, wherein the storage amount predetermined value is, for example, a sum of an amount/quantity of electricity used for actuating/activating the driving element 136 and an amount/quantity of electricity supplied to the electronic component 184 and the electronic component 186, so as to ensure a right/normal operation of the driving element 136.

In another embodiment, the fuel cell 170 may directly supply electricity to the driving element 136, the electronic component 184, and the electronic component 186 to reduce loss of electric energy. For example, in an initial operation stage of turning on the heating device 100 and the fuel cell 170 does not generate enough electricity yet, the electric energy storage unit 182 is used to supply electricity to the driving element 136; when the heating device 100 has run for a period of time and the fuel cell 170 generates enough electric energy, the fuel cell 170 directly supplies electricity to the driving element 136, the electronic component 184, and the electronic component 186 to reduce loss of electric energy. Moreover, the control unit 150 controls the fuel cell 170 to supply electricity to the electric energy storage unit 182 if the amount of electricity of the electric energy storage unit 182 is lower than a storage amount predetermined value; the fuel cell 170 is controlled to stop supplying electricity to the electric energy storage unit 182 if the amount of electricity of the electric energy storage unit 182 is higher than or equal to the storage amount predetermined value; wherein the storage amount predetermined value is, for example, a sum of an amount of electricity used for actuating/activating the driving element 136 and an amount of electricity supplied to the electronic component 184 and the electronic component 186 or an amount of electricity of the fully charged electric energy storage unit 182. However, the invention is not limited by the descriptions mentioned above.

Referring to FIG. 2, the heating device 100 of the embodiment includes a safety protection module 190. The safety protection module 190 is electrically connected to the control unit 150 to form a feedback circuit, and configured to send a safety signal to the control unit 150 so that the control unit 150 turns off the driving element 136. The safety protection module 190 includes a horizontal sensing element 190a. The horizontal sensing element 190a is, for example, gyroscope, which is disposed on and electrically connected to the control unit 150. When the horizontal sensing element 190a senses an inclining angle of the heating device 100 to be greater than an inclining angle predetermined value, the control unit 150 turns off the driving element 136, such that the hydrogen generating unit 130 stops providing hydrogen to the heating unit 140 for stopping reacting to generate heat, so as to avoid a situation that the heating unit 140 falls down to scald the user.

The safety protection module 190 of the embodiment further includes a contact sensing element (not shown). The contact sensing element is disposed on the first tank 132 and contacts the second tank 134, and is electrically connected to the control unit 150. When the contact sensing element senses that the second tank 134 is separated from the first tank 132, the control unit 150 turns off the driving element 136 to avoid a continuous operation of the driving element 136 to cause leakage of the liquid reactant in the first tank 132 under the situation that the second tank 134 is not disposed/assembled/configured to the first tank 132. The contact sensing element is, for example, a pressure sensor.

Moreover, the safety protection module 190 of the embodiment further includes a water level sensing element 190c. The water level sensing element 190c is disposed on the first tank 132 and is electrically connected to the control unit 150. When the water level sensing element 190c senses that a water level of the liquid reactant in the first tank 134 is lower than a water level predetermined value, the control unit 150 turns off the driving element 136 to avoid a continuous operation of the driving element 136 to waste electricity under the situation that the liquid reactant is inadequate. The water level sensing element 190c is, for example, a submerged water level sensor, a hydrostatic submerged water level sensor, or other devices used for detecting a water level.

The safety protection module 190 of the embodiment further includes a position sensing element 190b. Since the fuel cell 170 may be detachably connected to the hydrogen generating unit 130 and the position sensing element 190b is disposed on the hydrogen generating unit 130 and is electrically connected to the control unit 150, the position sensing element 190b turns off the driving element 136 through the control unit 150 when the position sensing element 190b senses that the fuel cell 170 is detached from the hydrogen generating unit 130. The position sensing element 190b is, for example, a pressure sensor.

A detailed structure of the heating unit 140 of the embodiment is described below. Referring to FIG. 1, FIG. 2 and FIG. 4, besides the catalyst layer 142, the heating unit 140 of the embodiment further includes a porous structure 144, a main body 146, and a cover 148. The main body 146 is connected to the hydrogen generating unit 130 through a connecting portion 146a thereof, and carries the catalyst layer 142. The temperature sensing element 160c is, for example, disposed on the connecting portion 146a for sensing a temperature of the heating unit 140. The porous structure 144 is disposed on the main body 146 and is located between the catalyst layer 142 and the hydrogen generating unit 130, and the cover 148 covers the porous structure 144 and the catalyst layer 142. A material of the porous structure 144 is, for example, a heat-resistant porous material such as porous metal foam, ceramic fiber or asbestos/rock wool, etc., and the porous structure 144 is used as impedance for gas flow between the catalyst layer 142 and the hydrogen generating unit 130, such that the hydrogen come from the hydrogen generating unit 130 may be more evenly/uniformly provided to the catalyst layer 142, so as to improve a reaction efficiency of the hydrogen and the oxygen at the catalyst layer 142.

A detailed transporting method for the liquid reactant and the hydrogen of the embodiment is described below. Referring to FIG. 2, FIG. 5 and FIG. 6, the hydrogen generating unit 130 of the embodiment includes an airflow channel 130a and a first guide structure 130b. The airflow channel 130a is connected between the second tank 134 and the connecting portion 146a of the heating unit 140, and the first guide structure 130b is, for example, a conducting pipe and is connected between the second tank 134 and the fuel cell 170. A part of the hydrogen (indicated by 70 in FIG. 5 and FIG. 6) generated through the reaction of the liquid reactant (indicated by 50 in FIG. 5 and FIG. 6) and the solid reactant (indicated by 60 in FIG. 6) within the second tank 134 flows through the airflow channel 130a to reach the heating unit 140. An another part of the hydrogen 70 generated through the reaction of the liquid reactant 50 and the solid reactant 60 within the second tank 134 flows through the first guide structure 130b to reach the fuel cell 170. In another embodiment, the first guide structure 130b may also be connected between the airflow channel 130a and the fuel cell 170, or other places used for guiding the hydrogen into the fuel cell 170.

Moreover, the hydrogen generating unit 130 further includes a second guide structure 130c and a third guide structure 130d, a containing space S2 of the second tank 134 is used for containing the solid reactant 60 and has a fourth guide structure 134a therein. The second guide structure 130c is, for example, a conducting pipe, and is connected between the driving element 136 and the first tank 132. The third guide structure 130d is, for example, a conducting pipe, and is connected between the driving element 136 and the fourth guide structure 134a of the second tank 134. The fourth guide structure 134a is aligned to the middle of the solid reactant 60. The driving element 136 is used for driving the liquid reactant 50 in the first tank 132 to sequentially flow through the second guide structure 130c, the driving element 136, and the third guide structure 130d to reach the second tank 134, and then the liquid reactant 50 flows through the fourth guide structure 134a to reach the solid reactant 60. According to the structure of the embodiment of the invention, the channel for the hydrogen 70 flowing through and the channel for the liquid reactant 50 flowing through are separated and are not interfered with each other, which avails outflow of the hydrogen 70 and inflow of the liquid reactant 50.

Referring to FIG. 6, the first tank 132 of the embodiment has an annular space S1, the annular space Si contains the liquid reactant 50 and surrounds the second tank 134. According to such design, when the liquid reactant 50 reacts with the solid reactant 60 within the second tank 134 to heat up, the liquid reactant 50 in the annular space S1 of the first tank 132 may cool down the second tank 134, so as to avoid overheat of the second tank 134 to cause difficulty in replacement of the second tank 134 due to the above reaction. Moreover, when the liquid reactant 50 reacts with the solid reactant 60 within the second tank 134 to heat up, the second tank 134 with higher temperature may properly increase the temperature of the liquid reactant 50 in the annular space Si of the first tank 132, so as to increase a reaction rate of the liquid reactant 50 reacting with the solid reactant 60 after the liquid reactant 50 enters the second tank 134.

A detailed structure of the second tank 134 is described below. Referring to

FIG. 2, FIG. 6 and FIG. 7, besides the fourth guide structure 134a, the containing space S2 of the second tank 134 further includes a check valve 134b, a sealing element 134c, a breathable waterproof membrane 134d, a fixing component 134e, and a sealing element 134f. The sealing element 134c is fixed to the fixing component 134e and seals a gap between the fixing component 134e and an inner wall of the second tank 134, so as to prevent the hydrogen 70 in the containing space S2 from leaking out through the gap between the fixing component 134e and the inner wall of the second tank 134. The sealing element 134f is fixed to the fixing component 134e and seals a junction between the third guide structure 130d and the fourth guide structure 134a, such that the liquid reactant 50 may smoothly flow from the third guide structure 130d to the fourth guide structure 134a without leakage. A material of the sealing element 134c and the sealing element 134f is, for example, rubber or other suitable sealing materials.

The breathable waterproof membrane 134d is, for example, a polytetrafluoroethylene (PTFE) membrane, which is fixed to the fixing component 134e and covers the containing space S2, so as to prevent the liquid reactant 50 from moving away from the containing space S2 and so that the hydrogen 70 in the containing space S2 may move away from the containing space S2 through the breathable waterproof membrane 134d. The check valve 134b is disposed at a tail end of the fourth guide structure 134a to prevent the liquid reactant 50 in the containing space S2 from flowing back to the first tank 132 through the fourth guide structure 134a.

In summary, the embodiments of the invention have at least one of the following advantages. In the heating device of the embodiment of the invention, the hydrogen generating unit is used to generate the hydrogen, and the hydrogen is reacted with the oxygen in the air through catalysis of the catalyst layer to produce heat energy. Since the heating device of the embodiment of the invention produces the heat energy without using a conventional reaction of hydrocarbon and oxygen in the air reacted by the conventional heating device, carbon monoxide harmful to human body is not generated, such that usage safety of the heating device is improved. Moreover, based on high activity of the hydrogen, the catalyst layer may effectively catalyse the reaction of the hydrogen and the oxygen to generate heat energy without preheating, such that the heating device is more energy-saving and time-saving in usage. In addition, in the heating device of the embodiment of the invention, the driving element is used to drive the liquid reactant to move towards the solid reactant, and the control unit is used to control the operation of the driving element according to the temperature of the heating device, so as to automatically adjust a generating rate of the hydrogen generated through the reaction of the liquid reactant and the solid reactant according to a heating quantity demand/require, such that the heating device is more convenient in usage. Moreover, the control unit may automatically control the fuel cell to supply or not to supply electricity to the electronic components according to an amount of electricity of the electronic components of the heating device, so as to further improve usage convenience of the heating device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A heating device, comprising:
a hydrogen generating unit, comprising a first tank, a second tank, and a driving element, wherein the first tank contains a liquid reactant, the second tank contains a solid reactant, and the driving element is connected to the first tank and the second tank, and is configured to drive the liquid reactant to move from the first tank to the second tank, such that the liquid reactant reacts with the solid reactant to generate hydrogen;
a heating unit, connected to the hydrogen generating unit and comprising a catalyst layer, wherein at least a part of the hydrogen moves from the second tank to the heating unit and contacts the catalyst layer to react to generate heat energy;
a temperature sensing module, configured to sense at least one temperature of the heating device; and
a control unit, electrically connected to the driving element and the temperature sensing module, and controlling the driving element according to the at least one temperature of the heating device.

2. The heating device as claimed in claim 1, wherein the control unit turns on or turns off the driving element according to the temperature.

3. The heating device as claimed in claim 1, wherein the control unit controls a working state of the driving element according to the at least one temperature, so as to change a flowing rate of the liquid reactant flowing to the second tank.

4. The heating device as claimed in claim 1, further comprising a fuel cell connected to the hydrogen generating unit, wherein at least another part of the hydrogen moves to the fuel cell from the second tank, and reacts in the fuel cell to generate electric energy.

5. The heating device as claimed in claim 4, wherein the fuel cell is configured to supply electricity to the driving element.

6. The heating device as claimed in claim 4, further comprising an electronic module, wherein the control unit is electrically connected to the fuel cell and the electronic module, and controls the fuel cell to supply electricity or not to supply electricity to the electronic module according to an amount of electricity of the electronic module.

7. The heating device as claimed in claim 6, wherein the electronic module comprises an electric energy storage unit and an electronic component, the electric energy storage unit stores electric energy from the fuel cell and supplies electricity to the driving element and the electronic component, and the control unit controls the fuel cell to supply electricity or not to supply electricity to the electric energy storage unit according to the amount of electricity of the electric energy storage unit.

8. The heating device as claimed in claim 7, wherein the fuel cell is configured to supply electricity to the electronic component.

9. The heating device as claimed in claim 7, wherein when the amount of electricity of the electric energy storage unit is lower than a storage amount predetermined value, the control unit controls the electric energy storage unit to supply electricity to the driving element and not to supply electricity to the electronic component.

10. The heating device as claimed in claim 4, wherein the hydrogen generating unit comprises an airflow channel and a first guide structure, the airflow channel is connected between the second tank and the heating unit, the first guide structure is connected between the second tank and the fuel cell, a part of the hydrogen in the second tank flows through the airflow channel to reach the heating unit, another part of the hydrogen in the second tank flows through the first guide structure to reach the fuel cell, the second tank has a fourth guide structure, the fourth guide structure is aligned to the solid reactant, and the liquid reactant is configured to flow through the fourth guide structure to reach the solid reactant.

11. The heating device as claimed in claim 1, wherein the temperature sensing module comprises a first temperature sensing element, the first temperature sensing element is disposed on and electrically connected to the control unit, the first temperature sensing element senses a first temperature of the heating device at the control unit, and the at least one temperature comprises the first temperature.

12. The heating device as claimed in claim 1, wherein the temperature sensing module comprises a second temperature sensing element, the second temperature sensing element is disposed on the hydrogen generating unit and is electrically connected to the control unit, the second temperature sensing element senses a second temperature of the heating device at the hydrogen generating unit, and the at least one temperature comprises the second temperature.

13. The heating device as claimed in claim 1, wherein the temperature sensing module comprises a third temperature sensing element, the third temperature sensing element is disposed on the heating unit and is electrically connected to the control unit, the third temperature sensing element senses a third temperature of the heating device at the heating unit, and the at least one temperature comprises the third temperature.

14. The heating device as claimed in claim 1, further comprising a safety protection module, wherein the safety protection module is electrically connected to the control unit for sending a safety signal to the control unit, such that the control unit turns off the driving element.

15. The heating device as claimed in claim 14, wherein the safety protection module comprises a horizontal sensing element, the horizontal sensing element is electrically connected to the control unit, and when the horizontal sensing element senses an inclining angle of the heating device to be greater than an inclining angle predetermined value, the control unit turns off the driving element.

16. The heating device as claimed in claim 14, wherein the safety protection module comprises a contact sensing element, the contact sensing element is disposed on the first tank and is electrically connected to the control unit, and when the contact sensing element senses that the second tank is separated from the first tank, the control unit turns off the driving element.

17. The heating device as claimed in claim 14, wherein the safety protection module comprises a water level sensing element, the water level sensing element is disposed on the first tank and is electrically connected to the control unit, and when the water level sensing element senses that a water level of the liquid reactant in the first tank is lower than a water level predetermined value, the control unit turns off the driving element.

18. The heating device as claimed in claim 14, further comprising a fuel cell, wherein the safety protection module comprises a position sensing element, the fuel cell is detachably connected to the hydrogen generating unit, at least another part of the hydrogen moves to the fuel cell from the second tank, and reacts in the fuel cell to generate electric energy, the position sensing element is disposed on the hydrogen generating unit and is electrically connected to the control unit, and when the position sensing element senses that the fuel cell is detached from the hydrogen generating unit, the control unit turns off the driving element.

19. The heating device as claimed in claim 1, wherein the first tank has an annular space, and the annular space contains the liquid reactant and surrounds the second tank.

20. The heating device as claimed in claim 1, wherein the heating unit comprises a porous structure, and the porous structure is disposed between the catalyst layer and the hydrogen generating unit.
